(19) United States
(12) Patent Application Publication
(10) Pub. No.: US 2015/0276568 A1
(43) Pub. Date: Oct. 1, 2015

(54) MICRO-SCALE LIQUID-LIQUID-LIQUID EXTRACTION

(71) Applicant: UNIVERSITY OF OSLO, Oslo (NO)

(72) Inventors: Astrid Gjelstad, Oslo (NO); Stig Pedersen-Bjergaard, Oslo (NO); Knut Einar Rasmussen, Eiksmarka (NO)

(21) Appl. No.: 14/431,406

(22) PCT Filed: Oct. 1, 2013
(86) PCT No.: PCT/IB2013/003052

§ 371 Date: Mar. 26, 2015

Related U.S. Application Data
(60) Provisional application No. 61/708,325, filed on Oct. 1, 2012.

(51) Int. Cl. G01N 1/40; B01L 3/00

(52) U.S. Cl. CPC G01N 1/4005; B01L 3/5085; B01L 2200/0631

(57) ABSTRACT

The present disclosure relates to systems and methods for extraction of analytes (e.g from bodily fluids). In some embodiments, the systems and methods utilize plates (e.g., 96 well) plates and a supported liquid membrane to extract analytes of interest from biological other samples.

This application claims the benefit of U.S. Pat. Appl. Ser. No. 61/708,325, filed Oct. 1, 2012, which is incorporated herein by reference in its entirety.

### FIELD OF THE INVENTION

The present disclosure relates to systems and methods for extraction of analytes (e.g., from bodily fluids). In some embodiments, the systems and methods utilize plates (e.g., 96-well plates) and a supported liquid membrane to extract analytes of interest from biological or other samples.

### BACKGROUND OF THE INVENTION

In the modern pharmaceutical laboratory, determination of drugs and drug metabolites in biological fluids (e.g., blood, urine) normally involves the use of liquid chromatography coupled with mass spectrometry (LC-MS). However, before a biological fluid can be processed by LC-MS or other analytical instruments, some type of sample preparation is required. The purpose of the sample preparation is mainly to eliminate matrix components in the sample, as the matrix components can interfere with the LC-MS determination of the target drugs. This is evidenced by ion-suppression effects, which are frequently observed in LC-MS [1,2]. Additionally, the purpose of the sample preparation is to improve the compatibility of the biological fluid with the LC-MS instrumentation, as many matrix components in biological fluids can contaminate and reduce the performance of the equipment.

Normally, sample preparation is performed by protein precipitation (PP), by solid-phase extraction (SPE), or by liquid-liquid extraction (LLE) [3]. PP is performed for plasma or serum samples [3]. A small volume of the biological fluid is mixed with a precipitant, typically acetonitrile, and the proteins are precipitated. After this, the sample is centrifuged, and the supernatant is used for the LC-MS analysis. Due to simplicity and easy automation, PP is a very popular technique in the modern pharmaceutical laboratory. However sample clean-up (elimination of matrix components) is not very efficient and LC-MS analysis following PP can be prone to interferences.

Alternatively, sample preparation can be accomplished by SPE [3]. In SPE, the biological fluid is loaded in a small column with a certain stationary phase, and the target analytes are retained by the stationary phase. The stationary phase is then washed with different washing solutions to eliminate as many matrix components as possible, before the target analytes are eluted from the stationary phase in the final step. This eluate is then analysed by LC-MS. Compared to PP, SPE gives substantially better sample-clean-up, and SPE is easily automated in the 96-well format. Unfortunately, SPE is relatively expensive, the consumption of organic solvents is considerable, and LC-MS is prone to some interference from certain endogenous compounds.

LLE can also be used for sample preparation [3]. In LLE, a water immiscible organic solvent is added to a small volume of the biological fluid, the 2-phase system is subjected to strong agitation, and the target analytes are transferred into the organic solvent. Normally, the organic solvent is evaporated to dryness and re-constituted in a fluid compatible with LC-MS. LLE normally gives very efficient sample clean-up, but LLE is more difficult to automate in the 96-well format. It requires considerable amounts of organic solvent, and evaporation of the solvent is inconvenient and time consuming.

In recent years, substantial efforts have been reported to develop and refine sample preparation based on the LLE principle. Development of single-drop liquid-phase microextraction [4-7] and hollow-fibre liquid-phase microextraction [8-11] has received substantial interest, and in both techniques the miniaturization of the process has reduced the consumption of organic solvent used per sample to typically 5-25 μL. In both techniques, 3-phase extractions have been demonstrated for charged analytes [12,13], where target analytes have been extracted from an aqueous sample into a μL volume of organic solvent and further into a μL volume of an aqueous acceptor solution. Thus, the acceptor solution is aqueous and directly compatible with LC-MS and solvent evaporation is no longer required. Liquid-phase microextraction provides very high flexibility as the performance and selectivity can be tuned by the pH conditions in the sample and acceptor solutions, by the type of organic solvent used, and eventually by addition of ion-pair or carrier molecules to the extraction system. Although both single-drop and hollow-fibre liquid-phase microextraction is promising, implementation of these techniques into the 96-well format is difficult.

Effective, fast, and reasonably priced methods are needed.

### SUMMARY OF THE INVENTION

The present disclosure relates to systems and methods for extraction of analytes (e.g., from bodily fluids). In some embodiments, the systems and methods utilize plates (e.g., 96-well plates) and a supported liquid membrane to extract analytes of interest from biological or other samples. In some embodiments, the present invention provides systems, methods, and uses of purifying analytes from a sample. Such systems, methods, and uses find use in a variety of research, screening, clinical, and industrial applications.

For example, in some embodiments, the present invention provides a system comprising: a) a donor plate comprising a multi-well plate comprising a plurality of samples comprising an analyte of interest; and b) an acceptor plate comprising a solid support coated with a liquid membrane or, in some embodiments, a system comprising a) an acceptor plate comprising a multi well plate comprising a plurality of acceptor solutions; and b) a donor plate comprising a multi well plate comprising a plurality of solid supports coated with liquid membranes, and a plurality of samples comprising an analyte of interest, as well as methods and uses of such system to purify analytes of interest. In some embodiments, the multi-well plate is a 96-well plate. The technology is not limited in the type of multi-well plate that is used. For example, in some embodiments, the multi-well plate has from 5 to 5000 wells (e.g., a 6-well plate, 12-well plate, 24-well plate, 48-well plate, 96-well plate, 384-well plate, a 1536-well plate, etc.). The technology is not limited in the material that is used for the solid support. In some embodiments, the solid support is an inert porous polymer. In some embodiments, the solid support is made from polypropylene, polyethylene, polysulfone, polytetrafluoroethylene (e.g., “Teflon”), polyvinylidene difluoride, or a similar polymer. In some embodiments, the solid support comprises pores, e.g., having a size of 1 μm or smaller (e.g., 0.5 μm or smaller, preferably 0.45 μm or smaller or 0.30 μm or smaller). In some embodiments, the liquid membrane is an organic solvent (e.g., dihexyl ether, dodecyl acetate, n-hexadecane, isopentyl benzene, hexyl decanol, or kerosene). In some embodiments, the analyte of interest is a small molecule, a drug, a drug metabolite, a polypeptide, or a nucleic acid. In some embodiments, samples are biological or environmental samples.

Some embodiments of the technology provide related methods for purifying analytes from a sample. For example, some embodiments provide a method comprising contacting an embodiment of a system as described herein with a plurality of samples comprising an analyte of interest; and transferring the analyte of interest from the acceptor plate to the donor plate. The technology is not limited in the analyte that may be purified from the sample. For example, in some embodiments the analyte of interest is a small molecule, a drug, a drug metabolite, a polypeptide, or a nucleic acid. Moreover, the technology is not limited in the types of samples that are processed and/or that comprise an analyte of interest. For example, in some embodiments the methods find use in processing a sample that is a biological and/or an environmental sample. Accordingly, embodiments are provided for use of a system or method provided herein for the purification of an analyte of interest from a sample.

Additional embodiments are described herein and/or will be apparent to persons skilled in the relevant art based on the teachings contained herein.

### DESCRIPTION OF THE FIGURES

These and other features, aspects, and advantages of the present technology will become better understood with regard to the following drawings:

FIG. 1 shows an embodiment of the PALME technology described herein. FIG. 1(A) shows a bottom element, middle element, and a top element. The bottom element is the donor plate (sample), the middle element is the acceptor plate (artificial liquid membrane and acceptor solution), and the top element is a lid to prevent evaporation. FIG. 1(B) is a schematic diagram of one extraction well as viewed in cross section from the side.

FIG. 2 is a plot showing the recovery of analytes from a sample processed according to embodiments of the technology provided herein. The plot shows recovery by PALME of the analytes pethidine, haloperidol, methadone, and nertriptyline versus sample volume.

FIG. 3 is a plot showing recovery of analytes from a sample processed according to embodiments of the technology provided herein. The plot shows recovery by PALME of the analytes pethidine, haloperidol, methadone, and nertriptyline versus extraction time. It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Moreover, it should be appreciated that the drawings are not intended to limit the scope of the present teachings in any way.

### DEFINITIONS

To facilitate an understanding of the present technology, a number of terms and phrases are defined below. Additional definitions are set forth throughout the detailed description.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator and is equivalent to the term “and/or” unless the context clearly dictates otherwise. The term “based on” is not exclusive and allows for being based on additional factors not described, unless the context clearly dictates otherwise. In addition, throughout the specification, the meaning of “a”, “an”, and “the” include plural references. The meaning of “in” includes “in” and “on.”

As used herein, an “analyte” is any target substance, which is to be removed from a sample, e.g., for analysis, manipulation, purification, etc. For example, in some contexts an “analyte” is a drug or drug metabolite.

As used herein, the term “pore size” refers to an average diameter of the pores of a membrane, such as a polymeric membrane. The pore size corresponds to the size of the largest molecule that can permeate the membrane by passage through the pore.

### DETAILED DESCRIPTION OF THE INVENTION

The present disclosure relates to systems and methods for extraction of analytes (e.g., from bodily fluids). In some embodiments, the systems and methods utilize plates (e.g., 96-well plates) and a supported liquid membrane to extract analytes of interest from biological or other samples. In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless defined otherwise, all technical and scientific terms used herein have the same meaning as is commonly understood by one of ordinary skill in the art to which the various embodiments described herein belongs. When definitions of terms in incorporated references appear to differ from the definitions provided in the present teachings, the definition provided in the present teachings shall control.

Although the disclosure herein refers to certain illustrated embodiments, it is to be understood that these embodiments are presented by way of example and not by way of limitation.

Described herein is a technology for separating one or more analytes present in a sample, such as a fluid sample. In some embodiments, the present invention provides a system for isolating, concentrating, manipulating, removing, and/or collecting an analyte from a sample. In some embodiments, the technology provides systems comprising a donor plate and an acceptor plate. The donor plate comprises a multi-well plate comprising a plurality of samples comprising an analyte of interest; and the acceptor plate comprises a solid support coated with a liquid membrane. In some embodiments, the acceptor plate comprises a multi-well plate comprising a plurality of acceptor solutions and the donor plate comprises a multi well plate comprising a plurality of solid supports coated with liquid membranes and a plurality of samples comprising an analyte of interest. The technology also provides methods and uses of such a system to purify analytes of interest. In some embodiments, the multi-well plate is a 96-well plate.

Typically the sample is a fluid sample having a known volume, which facilitates certain types of analysis of the analyte. The amount and precision of analyte separation from the sample can vary. In some embodiments, qualitative determination for the presence or absence of the analyte is performed and, in some embodiments, such an assay may use a less precise and/or less efficient analyte separation from the sample. In other embodiments, analyte is separated with increased precision and efficiency. In some embodiments, the separated analyte is subjected to further manipulation, such as quantification. The purity of the separated analyte will also vary, ranging from very pure to an analyte containing impurities from the sample. Purification of at least 2, 5, 10, 25, 50, 75, 100, 150, 250, 500, 750, 1,000, 5,000, 10,000, and/or 25,000-fold relative to the starting sample is provided by various embodiments.

The technology is not limited in the types of samples to which the systems and methods are applied. The samples are typically fluids. Sample fluids containing analytes include solutions or suspensions, such as solutions of molecularly dissolved materials or hydrodynamically suspended materials. Sample fluids that contain analytes include biofluids, such as whole blood, serum, plasma, cerebral-spinal fluid, urine, saliva, semen, sputum, bronchalveolar lavage fluid, joint aspirate, or wound drainage. Other sample fluids that can be used include various preparations containing bacteria, viruses, fungi, spores, cell cultures, fecal excrements, animal tissues or cells, vegetable tissues or cells, lysed ingredients thereof, or combinations thereof. It is understood that a solid sample containing an analyte can be homogenized or otherwise put into solution to facilitate the analysis of the sample. The source of the analyte can be an environmental sample. For example, waste water containing contaminants such as polymers or other chemicals. In another aspect, the sample could be a biowarfare sample, which is considered a sample that has been potentially contaminated with a biowarfare agent. For example, a biowarfare sample could be a water sample, such as a potable water sample, that may have been contaminated. In another aspect, the sample can be an air sample. In some embodiments, the sample is a food sample (e.g., raw materials, in-process samples, and finished-product samples). For example, in some embodiments, the sample is a liquid sample comprising, derived from, or prepared from, a food, e.g., a crop, raw or processed fruit or vegetable, meat (e.g., raw or processed meat), grain, bean, non-fluid dairy product (e.g., cheese, butter, ice cream, etc.), nuts, spices, ingredients, and syrups. In some embodiments, the sample is from a beverage. For example, in some embodiments, the sample comprises, is derived from, or is prepared from, milk, juice (fruit or vegetable juice), an alcoholic or fermented beverage, tea, coffee, and potable water. Pasteurized food or beverages may also be suitable sources.

Often a sample will have a known volume. Samples having known volumes find use in determining the concentration of analyte present in the sample at some point during the process, but also importantly if the amount of analyte that is present in the sample is to be correlated to the amount of analyte in the organism from which the sample was obtained. For example, if one desires to know how many drug molecules are present in a subject, a sample, such as a blood sample can be taken from the subject. This blood sample can be analyzed using the disclosed technologies and the amount of analyte present in the sample can be determined To determine how much analyte was present in the subject, one needs to determine how much analyte was present in the sample, in a known volume, and then extrapolate this to the amount of analyte present in the subject based on the knowledge, for example, of the total volume of, for example, the fluid in the subject.

The size of the known volume can depend on for example, the amount of analyte in the sample, the sensitivity of detection of the analyte, or the types of manipulation planned for the analyte. In some embodiments, the amount of sample that contains the analyte is from 0.5 μl to 1,000 μl, 0.5 μl to 900 μl, 0.5 μl to 800 μl, 0.5 μl to 700 μl, 0.5 μl to 600 μl, 0.5 μl to 500 μl, 0.5 μl to 400 μl, 0.5 μl to 300 μl, 0.5 μl to 200 μl, 0.5 μl to 100 μl, 0.5 μl to 50 μl, 0.5 μl to 25 μl, or 0.5 μl to 10 μl. For example, when the sample is a blood sample (e.g., for genetic testing, metabolite testing, drug testing, etc.), the known volume can be less than 40 μl, less than 30 μl, less than 20, less than 10 μl, or less than 5 μl, while, for example, samples of plasma or CSF (e.g., for viral load testing) may be greater than 200 μl, such as 250 μl, 300 μl, 400 μl, 500 μl, 600 μl, 700 μl, 800 μl, 900 μl, 1,000 μl, 2,000 μl, 5,000 μl, or 10,000 μl.

The technology provided herein is typically designed to isolate and/or manipulate analytes for which information is desired. Any analyte that has the properties necessary for extraction according to the technology can be targeted or manipulated. For example, the analyte extracted by the present technology can comprise virtually any species that is soluble in the extractant solvent. Both organic and inorganic species can be separated by the present technology. Further, polymeric species, e.g., biomolecules such as proteins, having a diameter of less than about the membrane pore size, can be separated by the present technology. Still further, multiple solute species can be separated by the present technology. In some embodiments, solutes comprise biological compounds, such as, but not limited to, polypeptides and proteins, and bio-affecting compounds, such as, but not limited to, drugs, pharmaceuticals, drug and pharmaceutical metabolites, enzymes, vitamins, and hormones. Still further, the present invention can be used to extract other inorganic and organic species, including pesticides, chlorinated organic compounds, fuels, petrochemicals, metal ions, metal complexes, and mixtures thereof. As such, the technology is not limited in the analyte that is extracted from a sample.

In various embodiments, the technology comprises use of porous solid support. In various embodiments, the porous solid support comprises (e.g., is made from) a material such as a polyolefin, a cellulose ester polymer, a polyamide, a polyacrylamide, a poly(sulfonated styrene), a glass, a polysulfone, and/or a polyacrylic. In some embodiments, the material comprises one or more of a cellulose acetate polymer, a polyethylene, a polypropylene, a polymethylpentene, and/or a polytetrafluoroethylene. In some embodiments, the porous solid support comprises pores having a pore size of 1.0 μm or smaller, e.g., 0.5 μm or smaller, preferably 0.45 μm or smaller or 0.3 μm or smaller. As an example, the pores of commercially available materials for porous solid supports are in the range of about 0.02 to about 2 μm, e.g., in effective diameter. Pores as small as 0.01 micron and as large as 10 microns are not unusual and a specific pore size is not necessarily important in a given application. Typically, commercial porous support thickness values range between 10 and 300 microns, although thicker supports are used for certain applications.

For aqueous sample solutions, the artificial liquid membrane typically comprises a water immiscible organic solvent. When a sample solution consists of analytes dissolved in organic solvent, the membrane is typically an aqueous-based system. Since sample pretreatment predominantly involves aqueous solutions, the supported membranes are typically chosen from aliphatic or aromatic hydrocarbons, ethers, nitriles, aldehydes or ketones, and alcohols that are immiscible with water. Some specific suitable organic liquids include 1-octanol, 2-octanone, diphenyl ether, nitrophenylalkylethers ranging from pentyl to decyl for the alkyl part, higher alkylpyridines such as 4-(1-butylpentyl) pyridine, 1-octyl-2-pyrrolidone, benzonitrile, diisopropylbenzene, cyclohexanone, tri-n-butylphosphate, triglycerides with alkyl chain lengths of 6 to 24 carbon atoms and fatty acid esters of cholesterol with alkyl chain lengths of 2 to 20 carbon atoms. In some embodiments, a mixture of solvents is used.

In one exemplary embodiment as discussed below, the extraction recoveries of drug substances was surprisingly high from human plasma after a short time, even though plasma is a very complex sample, and even though the contact area of the membrane is relatively low. This was not predictable for a person skilled in the art.

Experiments described herein demonstrate a totally new approach to LLE, namely parallel artificial liquid membrane extraction (PALME). In this disclosure, PALME is performed with flat membranes in a 96-well plate, which resembles plates for the physio-chemically different processes of filtration and parallel artificial membrane permeation assay (PAMPA) [14,15]. In PALME, target analytes are extracted from a small volume of biological fluid, through a flat artificial liquid membrane of a water-immiscible organic solvent, and into an aqueous acceptor solution. PALME provides very efficient sample clean-up in short time, and the consumption of organic solvent is reduced to only a few μL per sample. In addition, the 96-well plates are of low price, and PALME has potential for automation in existing laboratory platforms. The extracts are directly compatible with LC-MS, and the flexibility is high as extractions are easily tuned by changes in pH and organic solvent, and by addition of ion-pair reagents and carrier molecules. The sample clean-up of PALME is superior to PP, the cost per sample in PALME is superior to SPE, and the consumption of organic solvent in PALME is strongly reduced as compared to PP, SPE, and LLE. The disclosure describes the experiments, the optimization of principal operational parameters, and performance data.

Sample solutions (pH 12) containing the basic drugs pethidine, nortriptyline, methadone, and haloperidol as model analytes were pipetted into a 96-well donor plate. A sheet of porous polypropylene membrane (100 μm thick) was placed above the donor plate, and 2 μL of dihexyl ether was spotted on the flat membrane above each sample. The pores of the polypropylene membrane had a nominal pore size of 0.1 μm. Each dihexyl ether spot served as an artificial liquid membrane. The acceptor plate was placed above the membrane, and the acceptor wells were filled with 50 μL 20 mM HCOOH (acceptor solution). The donor plate and acceptor plate created a sandwich in which each sample and acceptor solution was separated by an artificial liquid membrane. The whole assembly was agitated at 900 rpm for 30 minutes to facilitate the extraction. During this time period, the model analytes were extracted as neutral species from the alkaline sample, through the artificial liquid membrane, and into the acidic acceptor solution where they were protonated. After PALME, the acceptor solutions were collected and analysed directly by liquid chromatography mass spectrometry (LC-MS). Extraction recoveries for the model analytes were in the range 55-89% from pure water samples, and in the range of 34 to 74% from human plasma. Data were repeatable within 1-12% RSD (n=6) for the model analytes when extracted from human plasma, and linearity (R²) was in the range 0.9955-0.9994 in the therapeutic concentration ranges. The limit of quantification was between 0.01 and 0.35 ng/mL for the four model analytes.

Thus, the present disclosure describes a new approach to liquid-liquid extraction termed parallel artificial liquid membrane extraction (PALME). PALME is performed with 96-well plates (e.g., commercially available plates), which allows for easy implementation, high-throughput, and full automation in existing laboratory platforms. PALME is ideally suited for small volumes of biological fluids (e.g., clean-up to avoid ion-suppression in LC-MS). High extraction recoveries are obtained, and excellent sample clean-up is achieved. The consumption of solvent per sample is limited to a few μL, and the extraction time is typically 30 minutes or less (e.g., 15 minutes or less).

The systems and methods find use in sample preparation and purification in a variety of research, screening, industrial and clinical applications. For instance, technology finds use in the extraction of trace levels of pharmaceuticals and other small molecules in aqueous media or biological samples of from 10 to 50 μL. Such extraction is useful in producing measurable signals by analytical instruments utilized for the analysis of pharmaceuticals at the nanogram or picogram level, especially when dealing with mixtures of analytes. Such analytical instruments can include high performance liquid chromatographs, gas chromatographs, capillary electrophoretic instruments, mass spectrometric detectors, and others.

### Experimental Section

### Chemicals.

Pethidine, nortriptyline, methadone, and haloperidol were obtained from Sigma Aldrich (St. Louis, Mo.). 2-Nitrophenyl octyl ether and dodecyl acetate were from Fluka (Buchs, Switzerland). n-Hexadecane, dihexyl ether, 2-nonanone, and 2-hexyl-1-decanol were from Sigma-Aldrich. Isopentyl benzene was from Tokyo Chemical Industry, Tokyo, Japan. Kerosene was from Norsk Medisinaldepot (Oslo, Norway). Methanol, formic acid, and sodium hydroxide were obtained from Merck (Darmstadt, Germany). Purified water was obtained from a Millipore Milli-Q water purification system (Millipore, Billerica, Mass.).

### Standard Solutions.

Stock solutions of each drug substance were prepared at 1 mg/mL in ethanol. The stock solutions were protected from light, and stored at +5° C. The stock solutions were used for spiking pure water or drug-free human plasma, and these were utilized as sample solutions.

### Biological Matrices and Sample Preparation.

Drug-free human plasma was obtained from Oslo University Hospital (Oslo, Norway). The samples were stored at 32° C. Plasma samples were spiked with the stock solutions containing the drug substances and with a solution of NaOH.

### Equipment and Procedure for Parallel Artificial Liquid Membrane Extraction (PALME).

PALME was accomplished utilizing a 96-well plate of polypropylene with 0.5 mL wells from Agilent (Santa Clara, Calif.) as donor plate, and a MAIPN4550 96-well MultiScreen-IP Filter Plate with 0.45 μm porous polyvinylidene fluoride (PVDF) Membrane (Millipore, Billerica, Mass.) as acceptor plate. Initial experiments revealed non-specific binding of the drug substances to the PVDF membrane, and therefore this membrane was removed from the filter plate prior to use. The PVDF membrane was replaced with a porous polypropylene membrane with a 100 μm thickness (Accurel PP 1E R/P Membrane, Wuppertal, Germany) This membrane has a nominal pore size of 0.1 μm. The actual porosity of this membrane was unknown.

First, samples of 200 μL were pipetted into the 96-well donor plate. The samples were either plasma samples (spiked or real) or samples of the four model drugs in pure water. Secondly, 200 μL of 20 mM NaOH was pipetted into each sample. A sheet of the porous polypropylene membrane was placed above the samples. 2 μL of dihexyl ether was pipetted into polypropylene membrane above each sample to form the artificial liquid membrane. The artificial liquid membrane was immobilized in the polypropylene membrane by waiting for approximately 1 minute. Then, the acceptor plate was located above the polypropylene membrane and the entire assembly was clamped and fixed by tape. Finally, the acceptor wells were filled with 50 μL 20 mM HCOOH (acceptor solution) by a pipettor. The whole assembly was agitated at 900 rpm for 30 minutes to perform the PALME process. After PALME, each acceptor solution was collected by the pipettor and transferred for analysis by LC-MS.

### Liquid Chromatography-Mass Spectrometry (LC-MS).

The chromatographic system comprised a Dionex UltiMate 3000 WPS 3000 TSL autosampler, a LPG 3300 pump and a SRD 3300 degasser connected to a Thermo Scientific LTQ XL Linear Ion Trap Mass Spectrometer. Data acquisition and processing were performed using Xcalibur version 2.1 software from Thermo Scientific.

Chromatographic separation was accomplished with a 50 mm×1 mm I.D. Biobasic-C₈ column (Thermo Fisher Scientific, Waltham, Mass.) with average pore size of 300 Å, and particle diameter of 5 μm. The mobile phases consisted of A: 20 mM formic acid and methanol (95:5, v/v) and B: 20 mM formic acid and methanol (5:95, v/v). The flow rate was set to 50 μL/min. The injection volume was 5 μL. A linear gradient was run up to 100% mobile phase B in 15 min using 80% mobile phase A 20% mobile phase B as starting point. After these 15 min, the mobile phase composition was kept constant for 6 min. Subsequently, the column was flushed with 80% mobile phase A 20% mobile phase B, for 7 min at a flow rate of 80 μL/min before a new injection.

An electrospray ionization (ESI) source operated in the positive ionization mode was used to interface the HPLC and the MS. Analyses were performed with selected reaction monitoring (SRM) using He as a collision gas. The quantifier SRM transitions where used to quantify the compounds while the qualifiers where used as confirmatory signals. The SRM transitions and collision energies are shown in Table 1.

Sheath gas was set to 25 units, aux gas 5 units, capillary temperature 250° C., and the spray voltage to 4 kV.

### Calculation of Recovery.

Recovery (R) was calculated according to the following equation for each analyte:

$$R = ( \frac{{n}_{a , final}}{{n}_{d , initial}} ) \times 100 \% = ( \frac{{V}_{a}}{{V}_{d}} ) \times ( \frac{{C}_{a , final}}{{C}_{d , initial}} ) \times 100 \% \qquad ( 1 )$$

where n_{d,initial} and n_{a,final} are the number of analyte moles initially present in the sample (donor) and the number of analyte moles finally collected in the acceptor solution, respectively. Vₐ is the volume of acceptor solution, V_{d} is the sample (donor) volume, C_{a,final} is the final concentration of analyte in the acceptor solution and C_{d,initial} is the initial analyte concentration within the sample (donor).

### Results

### Working Principle.

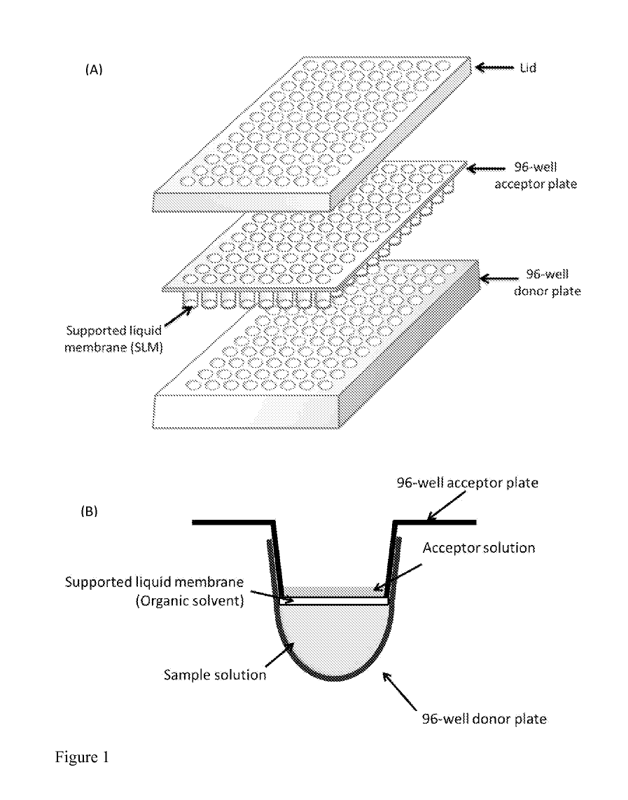

Parallel artificial liquid membrane extraction (PALME) was performed from pure water samples containing the basic drug substances pethidine, nortriptyline, methadone, and haloperidol as model analytes. The concentration of each basic drug was 250 ng/mL. Sodium hydroxide was added to the sample to a final concentration of 10 mM. The latter was accomplished to ensure that the basic model analytes were uncharged in the sample. The sample volume was initially 250 μL, and samples were pipetted into the 96-well donor plate (bottom plate) as illustrated in FIG. 1(a),(b). n-Dihexyl ether was used as the organic solvent to create the artificial liquid membrane. 3 μL of n-dihexyl ether was pipetted into each filter membrane of polyvinylidene fluoride (PVDF) in the 96-well acceptor plate to make the supported liquid membrane (SLM). This small volume of n-dihexyl ether rapidly permeated into the pores of the filter membrane and was immobilized by capillary forces. This process was finished in less than 1 minute. Subsequently, 50 μL of 20 mM HCOOH was pipetted into the acceptor wells as acceptor solution. The two 96-well plates were sandwiched as shown in FIG. 1(a), a lid was located above the acceptor plate to avoid partial evaporation of the acceptor solution, and the whole assembly was agitated for 45 minutes to perform the extraction. During this process, the analytes were extracted as neutral species from the alkaline sample, through the thin artificial liquid membrane of n-dihexyl ether, and finally into the acidic acceptor solution. Due to the acidic conditions in the acceptor solution, the basic model analytes were ionized, and thereby prevented from being back-extracted into the artificial liquid membrane. The acceptor solutions were finally analyzed directly by LC-MS. All four model analytes were efficiently extracted in the PALME system and recovered in the acceptor solution. The high extraction efficiency was surprising, as the contact area of the artificial liquid membrane is relatively small. However, extraction recoveries were found to decrease with decreasing analyte concentration, and this was attributed to non-specific binding of the analytes to the PVDF filter membrane. Although different solvents were tested as alternatives to n-dihexyl ether, non-specific binding to the PVDF material remained as a problem. A brief search for a similar commercially available 96-well filter plate with polypropylene membranes instead of PVDF was unsuccessful. Therefore, it was decided to remove the individual PVDF membranes of the acceptor plate, and squeeze and clamp a sheet of porous polypropylene between the sample plate and the acceptor plate as described above. The sample volume was increased to 400 μL, and the volume of n-dihexyl ether was decreased to 2 μL. With the polypropylene membrane, non-specific binding of the analytes was not observed, and recoveries became independent of the analyte concentration. PALME was successful, and recoveries after 45 minutes extraction were 89, 73, 70, and 55% for pethidine, haloperidol, methadone, and nortriptyline, respectively. The repeatability was acceptable between 4 individual wells, with relative standard deviations in the range of 4 to 11% for the four model analytes. Based on these experiments, the PVDF membranes of the commercial filter plate was removed and replaced by the polypropylene membrane for the rest of this study.

### Optimization of Operational Parameters.

In a next series of experiments, different operational parameters were studied and optimized. First, different organic solvents were tested as artificial liquid membrane. Eight different solvents were selected based on earlier and related experience from hollow-fiber liquid-phase microextraction [16]. In all cases, 2 μL solvent was pipetted into the polypropylene membrane. This volume of solvent provided a spot of similar size as the diameter of the sample acceptor well (6 mm) All the solvents were immiscible with water, and the reason for this was to prevent leakage of the artificial liquid membrane to the acceptor/sample during extraction. Also, all the solvents were relatively non-volatile, to prevent partial evaporation during PALME. The solvents were hydrophobic in nature, and they all were rapidly immobilized in the pores of the polypropylene membrane by capillary forces. Extraction recoveries with the different solvents after 45 minutes of PALME are summarized in Table 1. As seen from the data, the extraction performance and selectivity were influenced by the type of solvent. Among the solvents tested in this work, n-dihexyl ether was selected for the rest of the study as this solvent provided highest recovery for the current model analytes.

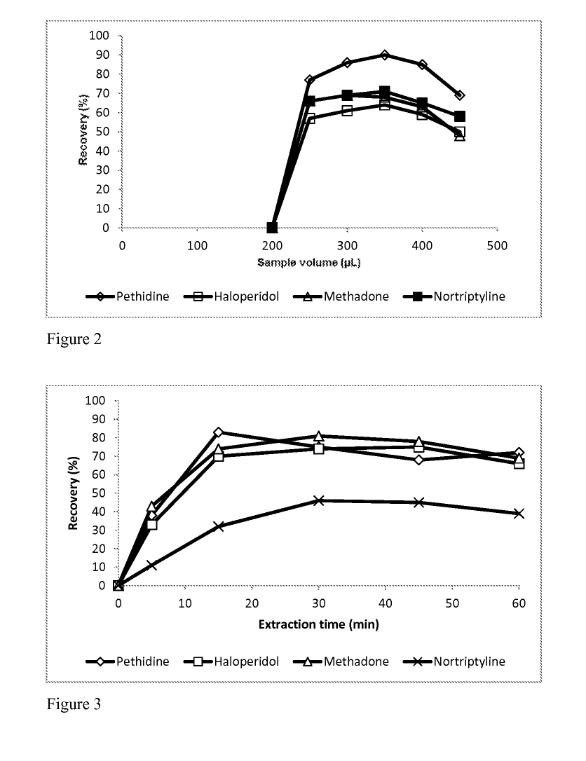

In a next series of experiments, different sample volumes were tested in the donor plate. In these experiments, the acceptor volume was 50 μL and the extraction time was 45 minutes. The results are shown in FIG. 2. With 200 μL sample or less, no model analytes were detected in the acceptor solution after PALME. In these cases, the filling of each donor well was insufficient, and the sample was not in contact with the artificial liquid membrane when the whole assembly was strongly agitated (900 rpm). On the other hand, with sample volumes in the range 250 to 450 μL, PALME was successful. With these sample volumes, the sample came in contact with the artificial liquid membrane when the whole assembly was agitated. Recoveries from different sample volumes in the range 250 to 400 μL appeared not to be statistically different, whereas a minor decrease was observed at 450 μL. In the latter case, the donor well was almost full, agitation of the sample was partly suppressed, and the extraction efficiency decreased slightly. Sample volumes above 450 μL were not relevant in the current set-up as these over-filled the donor well. Using the original membranes (PVDF) of the filter plate, the maximum sample volume decreased to 250 μL.

In a subsequent series of experiments, different acceptor volumes were tested in the acceptor plate. Acceptor volumes of 50, 100, and 150 μL all provided excellent extraction after 45 minutes, and recoveries were comparable. This demonstrated that a 50 μL acceptor volume was sufficiently, and that the extraction capability was not limited by the acceptor volume at 50 μL. In order to gain some pre-concentration during PALME, 50 μL acceptor solution was utilized during the rest of this study. With PALME from 400 μL sample to 50 μL acceptor solution, the four model analytes were enriched by a factor of 4.4-7.1 after 45 minutes.

Furthermore, the agitation speed was varied to investigate the effect on the PALME recoveries. In this experiment, different agitation rates between 0 and 1200 rpm were tested. The recoveries increased with increasing agitation rate up to about 600-900 rpm, whereas no further gain in extraction performance was observed as the agitation rate was increased above 900 rpm. Thus, agitation at 900 rpm was accomplished during the rest of this work. This strong agitation induced convection in both the sample and the acceptor, which was useful for the mass transfer.

In a final optimization experiment, the extraction time was varied between 0 and 60 minutes. Extraction recoveries versus extraction time are plotted in FIG. 3. Pethidine, haloperidol, and methadone were all extracted with relatively high recoveries. For these analytes, the PALME system entered equilibrium after 15 minutes, and no further gain was observed in extraction recovery when the extraction was performed for more than 15 minutes. In this case, the PALME system was capable of handling 96 samples in 15 minutes of extraction, even with 96-well plates not optimized for PALME yet. For nortriptyline, which provided lower recovery, 30 minutes was required for the PALME extraction to enter equilibrium. For the rest of this study, 30 minutes was selected as extraction time.

Extraction from Plasma.

In a next set of experiments, PALME was tested from spiked plasma samples. With a plasma sample containing 100 ng/mL of each drug substance, recoveries were 74, 37, 70, and 34% for pethidine, haloperidol, methadone, and nortriptyline, respectively. The high extraction efficiencies from plasma were unexpected, as the drugs are highly bound to proteins in plasma. Recoveries were lower from plasma than from pure water (compared with data in Table 2), and this was probably due to protein binding. However, as discussed in below, the differences in recovery were corrected for by establishing the calibration curved with drug-free plasma samples spiked with known amount of the four model drugs.

### Evaluation.

First, PALME combined with LC-MS was tested for linearity. The data are shown in Table 3. The therapeutic range for pethidine is 100-800 ng/mL [17], and therefore linearity was checked in the range from 50 to 1000 ng/mL. As seen from the data, excellent linearity was obtained with a R²-value of 0.9994. The other three drugs were also tested for linearity in their relevant concentration ranges, and the R²-values ranged between 0.9955 and 0.9984.

Next, the repeatability of PALME combined with LC-MS was tested. The data are shown in Table 3. For pethidine, repeatability was measured at 100, 500, and 1000 ng/mL based on six replicates each. As seen from the data, peak areas were repeatable within 4-6%. The other drugs were also tested for repeatability, and the RSD-values were in the range 1-12%.

Finally, the limits of quantification (LOQs) were established. The analyte peak heights obtained from PALME from plasma (drug concentration of 5 ng/mL) were compared with the peak height of the noise. With a signal-to-noise ratio of 10, the LOQ for pethidine, haloperidol, methadone and nortriptyline were found to be 0.12; 0.35; 0.01; and 0.28 ng/mL, respectively. All the LOQs were well below the levels of the therapeutic ranges (Table 3) and were therefor considered as fully acceptable.

### Extraction of a Patient Sample.

In a last experiment, a patient sample containing haloperidol was prepared with the presented PALME technique, and the extracts were analyzed on LC-MS/MS as described earlier. The calculation of the haloperidol concentration in the sample was based on a calibration curve established from PALME from spiked plasma samples. The calibration curve was in the range 5-100 ng/mL. An average concentration from three parallels showed a haloperidol concentration of 5.2 ng/mL in the real plasma sample. The quantitative result was compared with a reference laboratory, which reported a haloperidol concentration of 3.8 ng/mL after protein precipitation followed by LC-MS.

TABLE 1
LC-MS/MS data

| | | | | Collision |
|---|---|---|---|---|
| Drug | SRM Transition | Quantifier | Qualifiers | energy |
| Nortriptyline | 264.15 → 233.20 | 233.20 | 153.2, 191.2 | 24% |
| Pethidine | 248.16 → 220.10 | 220.10 | 174.1, 202.1 | 27% |
| Methadone | 310.20 → 265.15 | 265.15 | — | 25% |
| Haloperidol | 376.19 → 165.00 | 165.00 | 123.0, 358.2 | 29% |

TABLE 2
PALME recoveries with different organic
solvents as artificial liquid membrane

| | Recovery (%)^{a} | | | |
|---|---|---|---|---|
| Solvent | Pethidine | Haloperidol | Methadone | Nortriptyline |
| Dodecyl acetate | 83 | 69 | 70 | 50 |
| n-Hexadecane | 80 | 40 | 69 | 36 |
| Isopentyl benzene | 87 | 62 | 69 | 34 |
| n-Dihexyl ether | 89 | 73 | 70 | 55 |
| 2-Nitrophenyl | 76 | 66 | 58 | 56 |
| octyl ether | | | | |
| 2-Nonanone | 5 | — | 1 | — |
| Hexyl decanol | 71 | 61 | 63 | 59 |
| Kerosene | 66 | 8 | 63 | 20 |

^{a}n = 4

TABLE 3
Linearity and repeatability of PALME from plasma combined with LC-MS/MS

| | Therapeutic | Conc. range | | % RSD^{b} | | | | |
|---|---|---|---|---|---|---|---|---|
| | range^{a} | studied in this | | 5 | 25 | 100 | 500 | 1000 |
| | (ng/mL) | work (ng/mL) | R² | ng/mL | ng/mL | ng/mL | ng/mL | ng/mL |
| Pethidine | 100-800 | 50-1000^{c} | 0.9994 | — | — | 6 | 4 | 5 |
| Haloperidol | 5-17 | 5-100^{d} | 0.9983 | 8 | 9 | 9 | — | — |
| Methadone | 100-500 | 50-750^{d} | 0.9955 | — | — | 5 | 1 | — |
| Nortriptyline | 20-200 | 10-250^{d} | 0.9984 | — | 12 | 12 | — | — |

^{a}From reference [17]
^{b}n = 6
^{c}Six concentration levels
^{d}Five concentration levels

### REFERENCES

[1] F. T. Peters, D. Remane, Anal. Bioanal. Chem. 403 (2012) 2155.
[2] A. V. Eeckhaut, K. Lanckmans, S. Sarre, I. Smolders, Y. Michotte, J. Chromatogr. B 877 (2009) 2198.
[3] H. Kataoka, K. Saito, A. Yokoyama, in Handbook of Sample Preparation (Ed. J. Pawliszyn and H. L. Lord), John Wiley & Sons, Hoboken, N.J., USA, 2010, p. 285.
[4] H. Liu, P. K. Dasgupta, Anal. Chem., 68 (1996) 1817.
[5] M. A. Jeannot, F. F. Cantwell, Anal. Chem., 68 (1996) 2236.
[6] Y. He, H. K. Lee, Anal. Chem., 69 (1997) 4634.
[7] R. Lucena, M. Cruz-Vera, S. Cardenas, M. Valcarcel, Bioanalysis 1 (2009) 135.
[8] S. Pedersen-Bjergaard, K. E. Rasmussen, Anal. Chem., 71 (1999) 2650.
[9] L. Zhu, C. Tu, H. K. Lee, Anal. Chem., 73 (2001) 5655.
[10] L. S. de Jager, A. R. J. Andrews, Analyst 126 (2001) 1298.
[11] S. Pedersen-Bjergaard, K. E. Rasmussen, J. Chromatogr. A 1184 (2008) 132.
[12] M. Ma, F. F. Cantwell, Anal. Chem., 70 (1998) 3912.
[13] K. E. Rasmussen, S. Pedersen-Bjergaard, M. Krogh, H. Grefslie Ugland, T. Gronhaug, J. Chromatogr. A 873 (2000) 3.
[14] P. V. Balimane, Y.-H. Han, S. Chong, International Drug Discovery, 5 (2010) 83.
[15] B. Faller, Current Drug Metabolism, 9 (2008) 886.
[16] A. Gjelstad, H. Taherkhani, K. E. Rasmussen, S. Pedersen-Bjergaard, R. E. Majors, LCGC North America 29 (2011) 1038.
[17] M. Schulz, A. Schmoldt, Pharmazie 58 (2003) 447.

All publications and patents mentioned in the above specification are herein incorporated by reference in their entirety for all purposes. Various modifications and variations of the described compositions, methods, and uses of the technology will be apparent to those skilled in the art without departing from the scope and spirit of the technology as described. Although the technology has been described in connection with specific exemplary embodiments, it should be understood that the invention as claimed should not be unduly limited to such specific embodiments. Indeed, various modifications of the described modes for carrying out the invention that are obvious to those skilled in the art are intended to be within the scope of the following claims.

1. A system, comprising:
a) a donor plate comprising a multi well plate comprising a plurality of samples comprising an analyte of interest; and
b) an acceptor plate comprising a solid support coated with a liquid membrane.

2. A system, comprising:
a) an acceptor plate comprising a multi well plate comprising a plurality of acceptor solutions; and
b) a donor plate comprising a multi well plate comprising a plurality of solid supports coated with liquid membranes, and a plurality of samples comprising an analyte of interest.

3. The system of claim 1, wherein said multiwall plate is a 96-well plate.

4. The system of claim 1, wherein said solid support is an inert porous polymer support.

5. The system of claim 1, wherein said porous solid polymer support is made from polypropylene, polyethylene, polysulfone, polytetrafluoroethylene, or polyvinylidene difluoride.

6. The system of claim 1, wherein said porous solid polymer support comprises pores that are 0.50 μm or smaller.

7. The system of claim 1, wherein said porous solid polymer support comprises pores that are 0.45 μm or smaller.

8. The system of claim 1, wherein said liquid membrane is an organic solvent.

9. The system of claim 8, wherein said organic solvent is selected from the group consisting of dihexyl ether, dodecyl acetate, n-hexadecane, isopentyl benzene, hexyl decanol, and kerosene.

10. A method, comprising:
a) contacting a system of claim 1 with a plurality of samples comprising an analyte of interest; and
b) transferring said analyte of interest from said acceptor plate to said donor plate.

11. The method of claim 10, wherein said analyte of interest is a small molecule, a drug, a polypeptide, or a nucleic acid.

12. The method of claim 10, wherein said samples are biological samples, environmental samples, food samples, or beverage samples.

13. The use of the system of claim 1 in the purification of an analyte of interest from a sample.
